(19) United States
(12) Patent Application Publication
(10) Pub. No.: US 2005/0114559 A1
(43) Pub. Date: May 26, 2005

(54) Method for efficiently processing DMA transactions

(76) Inventor: George B. Miller, Hingham, MA (US)

Correspondence Address: Robert Gove;CSP Inc., 43 Manning Road, Billerica, MA, 01821, US

(21) Appl. No.: 10/717,771

(22) Filed: Nov. 20, 2003

(51) Int. Cl. G06F 12/00

(52) U.S. Cl. 710/22; 711/147; 711/118

(57) ABSTRACT

The data rate at which DMA transactions are processed by a General Purpose Computer System can be significantly improved by directing housekeeping type transactions directly to the CPU bus and by directing data type transactions directly to Shared Memory. By assigning memory address ranges to particular I/O devices and by programming PCI Interface Logic on a System Controller to detect these ranges and to direct DMA requests directly to either the CPU bus or to the Memory Controller depending upon the address range detected, the speed with which DMA transactions can be processed is enhanced.

### BACKGROUND OF THE INVENTION

Field of the Invention: This invention relates to the field of general purpose computer systems and to the efficient and coherent processing of DMA transactions between I/O devices and shared memory.

### BACKGROUND OF THE INVENTION

General purpose computer systems are designed to support one or more central processors (CPUs) on a common CPU bus, one or more external I/O devices on one or more standard I/O buses, a shared system memory, and a system controller that serves as a communications interface between the CPU bus, the I/O bus, and the shared system memory. All of the CPUs and at least one, but typically most, of the I/O devices can communicate with the shared system memory. Cache memory has been incorporated into the CPUs of such computer systems in order to minimize the number of bus cycles or bandwidth needed to service transactions between the CPUs and the shared memory. This CPU cache architecture frees up bandwidth for other devices, such as I/O, to access the shared memory thereby speeding up the overall computer system operation.

With multiple system devices able to write to and read from the shared memory it is necessary to prevent inconsistencies in the value of data between a version in CPU cache and a version in shared memory. This is accomplished by implementing a data value consistency protocol in the computer system. This protocol is referred to as a cache coherency protocol and it typically is incorporated into the functionality of each processor in the form of a cache controller. A common protocol used to maintain coherency is called snooping.

The external I/O devices mentioned above can be, for example, disk drives, graphical devices, network interface devices, multimedia devices, or I/O processors and they are typically designed to interface to standard bus protocols, such as the PCI bus protocol. Alternatively, the I/O bus and external I/O devices could be replaced by another CPU bus and CPU units, so the Computer System would have two CPU subsystems. I will refer to the external I/O devices simply as I/O devices. In order to more rapidly move information between these I/O devices and the shared system memory, computer designers invented a mechanism for off-loading this rapid information movement from the CPU. This mechanism is called Direct Memory Access (DMA).

In order to maintain CPU cache coherency, it is necessary to ensure that all DMA read and write transactions between I/O devices and shared memory adhere to coherency rules. However, standard I/O devices may provide only partial support for cache coherency functionality. In this case, the system controller can incorporate functionality that operates to enforce cache coherency. Regardless, a cache coherency protocol is run by every CPU in the system that supports on-chip cache. As the cache memory and associated coherency functionality are tightly integrated into the design of each CPU device, the CPU is much better positioned in the computer system to perform this cache coherency protocol efficiently.

Some system controllers are designed to be used in multiple different standard modes of operation; two of which are a coherent mode and a non-coherent mode. The non-coherent mode is well suited to very rapidly move large amounts of data between I/O and shared memory while the coherent mode is better suited for processing housekeeping type transactions which are typically small transactions dealing with the properties of data as opposed to the data itself. For example, these types of transactions would contain status information such as packet received or sent, checksum information, or information about the next DMA transaction. These housekeeping types of transactions might not be directly controlled or generated by an application program.

More specifically, when a system controller is operating in the non-coherent mode of operation, it transmits DMA requests from I/O directly to the shared memory. Although this is the highest bandwidth communications path between I/O and the shared memory, such non-coherent transactions may result in the creation of inconsistencies in the various versions of data stored at different locations in the computer system.

On the other hand, when a system controller is operating in the coherent mode, it receives DMA requests from the I/O and buffers them, and then utilizes its own coherency functionality to communicate with the cache at each CPU. This communication could be a message to flush cached data before a read request or invalidate cached data before a write request. As a system controller's coherency functionality does not operate nearly as efficiently as the CPUs coherency functionality, processing DMA requests in the coherency mode takes much more time than processing the same DMA request in the non-coherent mode. Therefore, it is not desirable to utilize the coherent mode of system controller operation to process DMA requests.

In order to successfully complete I/O transactions in the non-coherent mode, it is necessary for the I/O device drivers to enforce coherency. Unfortunately, standards-based I/O device drivers do not usually arrive from the manufacturer ready to support cache coherency for I/O-processor bus transactions that operate in a non-coherent manner, so typically it is necessary for the customer to modify the I/O device driver to enable such non-coherent operation. Such modification of the I/O device driver can be time consuming and costly and defeats the purpose of using general purpose, standards based I/O units.

One method for enforcing cache coherency during DMA transactions between I/O and shared memory is to inhibit the CPU cache from storing portions of shared memory that were accessible to the I/O units. In other words, the CPU cache would be effectively turned off and the CPU would be forced to access shared memory, as needed, on a word-by-word basis. This would serve to unnecessarily slow the operation of the processor and hence the entire system.

As mentioned above, another solution to the cache coherency problem is to incorporate cache coherency functionality into the system controller. Essentially, the system controller buffers all I/O requests until the transactions can be processed such that the value of all versions of the data are maintained in a coherent fashion. This process can involve the flushing or invalidating of cache as mentioned previously.

Although providing cache coherency at the system controller has resulted in the rapid processing of DMA transactions between I/O and shared memory, and although this cache coherency functionality does rapidly complete DMA transactions that involve merely housekeeping transactions, the system controller coherency functionality continues to be a significant bottle-neck for DMA transactions that involve the movement of large amounts of data from shared memory directly to I/O units (data reads) and to lesser extent slows DMA transactions involving large amounts of data from I/O units to shared memory (data writes).

### SUMMARY OF THE INVENTION

I have discovered that it is possible to significantly increase the data rate of DMA transactions between I/O devices and shared memory, without the need to modify the I/O device drivers, by disabling the system controller coherency protocol and programming the system controller to transmit the I/O request directly to the CPU bus. Further, I have discovered that it is possible to increase the data rate for certain DMA transactions between I/O units and shared memory and at the same time very efficiently utilize the CPU bus by transmitting particular types of DMA transactions between I/O and shared memory either directly to shared memory or directly to the CPU bus. My method increases the data rate for certain types of DMA transactions and very efficiently utilizes the CPU bus thereby increasing overall system performance.

In the preferred embodiment of the invention, a general purpose computer system is used to assign two memory address ranges to the I/O bus address space. When the I/O device generates a DMA transaction request, a system controller that has been programmed to recognize the memory address ranges forwards requests with addresses that correspond to a particular range directly to either a CPU bus or to a memory controller.

In another embodiment of the invention, the general purpose computer only assigns one memory address range to the I/O bus address space and the system controller forwards all DMA requests with addresses that correspond to the range directly to the CPU bus.

### BRIEF DESCRIPTION OF THE DRAWINGS

FIG. 1 is a block diagram of a general purpose computer system;

FIG. 2 is a block diagram of the I/O interface device incorporated into a general purpose computer system;

FIG. 3a is a flow chart describing a DMA read transaction;

FIG. 3b is a continuation of the flow chart of FIG. 3a; and

FIG. 3c is a continuation of the flow chart of FIG. 3b.

### DETAILED DESCRIPTION OF THE PREFERRED EMBODIMENT

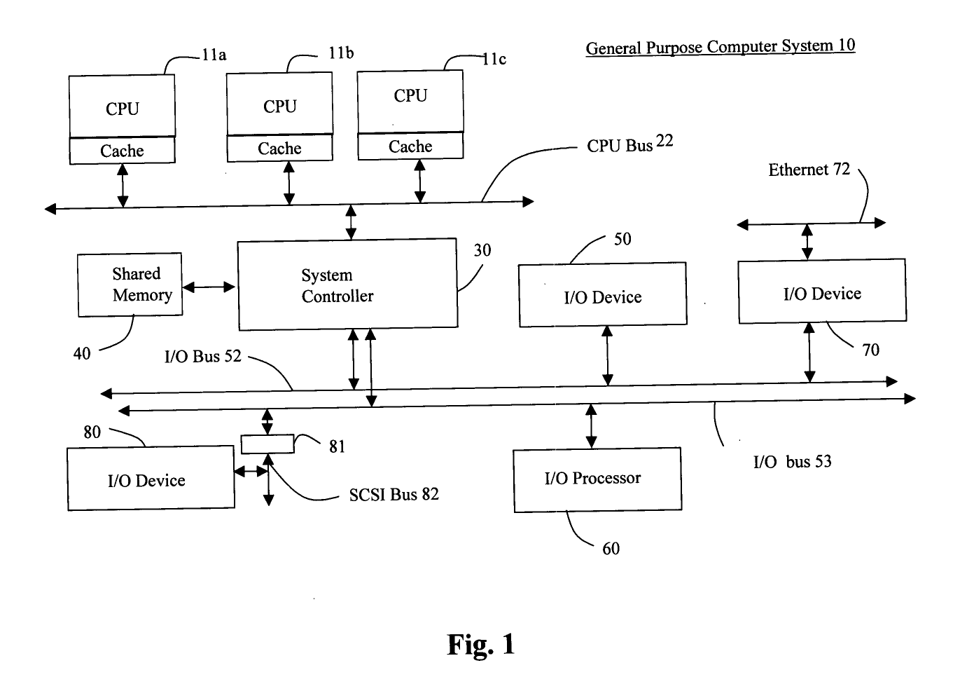

FIG. 1 is a high-level block diagram of a general-purpose computer system 10, hereinafter referred to as the computer system, which can be employed to implement the novel DMA transaction process described by this application. Such a computer system will typically have one or more central processing units (CPUs) 11a, b, and c, and associated cache memory in communication with a CPU bus 22. The CPU(s) enable much of the computer system's functionality. Among other things, they make and compare calculations, signal I/O devices to perform certain operations, and read and write information to memory. The cache associated with each CPU acts as a buffer, local to each CPU, for the storage of a version of data contained in the shared memory 40. Cache provides a mechanism for each CPU to very rapidly access a version of data that is contained in shared memory without using any CPU bus cycles. The CPU could be, for instance, a MPC7410 Power PC processor sold by the Motorola Corporation.

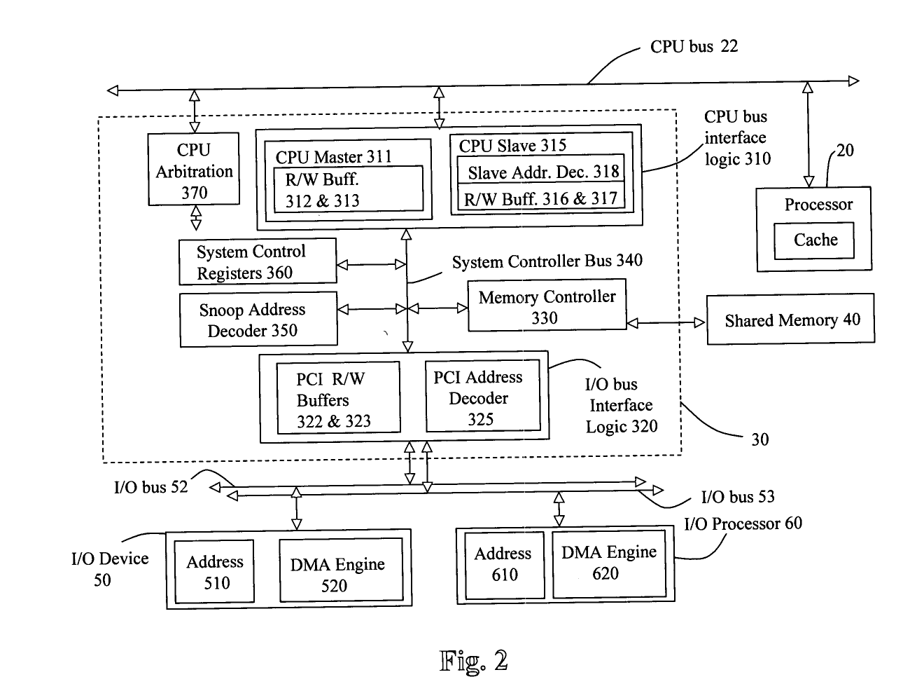

Continuing to refer to FIG. 1, a system controller 30 is in communication with the CPU bus 22, with shared memory 40, and with one or more I/O buses 52 & 53. Generally speaking, the system controller acts as a communication interface between the CPU bus 22, the I/O bus(s) 52 and 53, and the shared memory 40. All transactions directed to the shared memory from either the CPU bus or from the I/O buses are processed by the system controller. The system controller that I used in the computer system is the GT64260B system controller, sold by Marvell Semiconductor, Inc. but almost any other system controller could be used that provides similar functionality. A more detailed discussion of the system controller functionality will be undertaken later in this application with reference to FIG. 2.

Continuing to refer to FIG. 1, the I/O bus used in my implementation conforms to the PCI bus standard. Generally, the I/O bus serves as a way of expanding the computer system and connecting new peripheral devices, which are in this case represented by the external I/O devices. To make this computer system expansion easier, the industry has developed several bus standards. The standards serve as a specification for the computer system manufacturer and the external I/O device manufacturer. There are many I/O bus standards that can be utilized in the computer system described in this application, but for the purpose of explanation, I will refer to the well-known PCI bus standard. The I/O devices 50 and 70 are in communication with the I/O bus 52. These I/O devices could be disk drives, multimedia devices, network interface devices (NIC), printers, or any other device that provides information to and requests information from the computer system and which do not contain cache memory. Typically, I/O devices operate under the general control of the CPUs and the operating system. Alternatively, there could be more than one I/O bus incorporated into the computer system. I/O bus 53, could also adhere to the PCI bus standard or another I/O standard. Alternatively, but not shown, either or both bus 52 and 53 could be processor buses that support communication between one or more CPUs and non-cachable I/O devices In this case, I/O requests could be generated by either an I/O device or by one of these CPUs on behalf of an I/O device.

The shared memory 40 in this case is the MT48LC32M8 SDRAM sold by Micron Technology, Inc., although any type of random access memory, supported by the system controller could be used. The shared memory provides a single address space to be shared by all of the CPUs in the computer system and it stores data that the CPUs use to make calculations and operate the computer system and stores data that the external I/O devices can use or modify.

FIG. 2 represents a block diagram of the system controller 30 with associated CPU bus 22, CPU and cache 20, I/O buses 52 & 53, I/O device 50, and I/O processor 60. Going forward, I will refer to both the I/O device 50 and the I/O Processor 60 as I/O devices. The system controller 30, surrounded by a dotted line, incorporates a range of functionalities including, among other things, CPU and I/O bus interface logic 310 and 320 respectively, memory control 330, CPU bus arbitration 370, cache coherency in the form of a snoop address decoder 350, and system control registers 360. All of the system controller functionality, with the exception of the CPU arbitration 370, is connected to the system controller Bus 340. The system control registers 360 are used to control the behavior of all aspects of the system controller 30. These registers are typically programmed once by software at initialization of the computer system 10, however, some or all of the control registers 360 can be modified during the computer system operation. For example, certain system controllers can be programmed to control the size of DMA read requests, or decode interrupt signals, or signal interrupt completion.

In general, system controllers are available that are designed to be used in multiple standard modes of operation. Two standard modes are the non-coherent and coherent modes. The non-coherent mode is well suited to move large amounts of data between I/O devices and shared memory very rapidly while the coherent mode is better suited for processing housekeeping-type transactions which are typically small transactions dealing with the properties of data as opposed to the data itself. For example, housekeeping transactions could contain status information such as packet received or sent, checksum information, or information about the next DMA transaction. These housekeeping types of transactions might not be directly controlled or generated by an application program. Housekeeping type transactions should be exposed to the coherency protocol mentioned earlier. The Marvell Corporation GT64260B system controller product manuals explain how the controller can be programmed to enable both of these standard operational modes.

More specifically with reference to FIG. 2, the CPU bus interface logic 310 incorporates CPU master unit 311 and CPU slave unit 315. As these units suggest, the system controller can operate as a CPU bus master or CPU bus slave, depending upon which system resource generates the transaction request. The CPU master unit 311, among other things, performs read, write, and cache coherency operations on the CPU bus at the direction of the PCI bus interface logic 320 or the memory controller 330. The CPU slave unit 310, among other things, decodes CPU bus signals to detect requests in assigned memory address ranges, forwards these requests to the memory controller or the PCI interface logic, for instance, and drives CPU bus signals to provide data and signal completion in compliance with the CPU bus protocol.

Continuing to refer to FIG. 2, the CPU master unit 311 incorporates a read and a write buffer 312 and 313 respectively. The CPU master read buffer 312 stores up to four read requests that it receives from other system controller units. The read buffer operates to increase multiple read transaction efficiency by allowing multiple read transactions to be in progress simultaneously. The CPU master write buffer 313 functions to store write requests from other computer system resources (i.e., CPUs, I/O, or memory controller) until the requesting unit or device is ready to service the request. The write buffer 313 can store up to four write requests. The CPU slave 315 generally provides address decoding, buffers read/write transactions, forwards requests to other resources in the computer system, and drives CPU bus signals to provide data and signal completion in compliance with the MPC7410's CPU bus protocol. Specifically, the CPU slave unit incorporates a read buffer 316, a write buffer 317, and an address decoder 318. The CPU slave read buffer unit buffers read data from a computer system resource until the CPU is ready to accept it. Up to eight read transactions can be buffered in this manner. The CPU slave write buffer 317 is utilized to post write transactions, that is, the write address and data can be stored in this buffer until the requested computer system resource is ready to perform the write transaction. The CPU slave write buffer can post up to six write transactions. The CPU slave address decoder 318 associates memory address ranges with other computer system resources, for instance, an I/O device and it controls how certain transactions will be performed.

The PCI bus interface logic 320 incorporates the PCI address decoder 325 and the PCI read and write buffers numbered 322 and 323 respectively. The PCI bus interface logic can be programmed to decode I/O bus signals in order to detect requests from I/O devices in assigned memory address ranges, forwards these requests to other computer system resources, and drives I/O bus signals to provide data and signal completion in compliance with the PCI bus protocol. In compliance with the PCI specification, the registers that control the interface logic are accessible via the so-called PCI configuration space. Also, as previously mentioned, certain properties of the PCI interface logic are controlled by the system controller registers 360. Alternatively, the PCI interface logic could be programmed to decode processor bus signals if a processor bus instead of an I/O bus was incorporated into the computer system 10.

In the preferred embodiment of the invention, the PCI address decoder 325 operates to decode I/O bus signals in order to detect a request from I/O devices in two assigned memory address ranges. These address ranges correspond to addresses on the I/O bus at which I/O devices expect to access the shared memory. Depending upon the I/O request address detected, the interface logic forwards the request directly to either the memory controller unit or the CPU master unit. For example, a first memory address range could be assigned to all transactions that contained only data information and a second memory address range could be assigned to handle DMA requests that contained housekeeping information. In this case, the PCI address decoder is programmed to operate such that DMA requests detected in a first memory address range will cause the request to be forwarded directly to the memory controller 330 in a non-coherent manner and DMA requests detected in a second memory address range will cause the request to bypass the standard system controller coherency functionality and be forwarded directly to the CPU master 311 in the coherent manner suggested by my invention. The Marvell system controller product manuals contain enough information so that someone skilled in the art of computer design having read this description would be able to understand how to program the address decoder to operate in the manner described above. The preferred embodiment of the invention enables the computer system to take advantage of the efficiencies associated with processing DMA requests containing address information on the CPU bus 22 and the efficiencies associated with sending DMA requests containing only data directly to the memory controller.

In another embodiment of the invention, a single memory address range is assigned to handle all DMA requests from a particular I/O device. In this embodiment, the PCI address decoder is programmed to operate such that all DMA requests detected in the assigned memory address range will cause the request to be forwarded to the CPU bus interface logic which then propagates the request onto the CPU bus 22 where it is exposed to the cache coherency protocol. This method for processing DMA requests is particular advantageous when the request contains housekeeping-type information as it is important that this type of request be exposed to the cache coherency protocol. Placing this type of request onto the CPU bus is the most efficient method for processing them in a coherent manner and speeds up the overall operation of the computer system.

The one or more assigned memory address ranges could be of almost any size, limited only to the amount of shared memory assigned to any particular I/O device. It should be understood that the addresses contained in any particular address range do not have to be compact or contiguous. So, for example, if a range was composed of some number of smaller blocks of compact memory addresses, these number of blocks would be considered to be a single, logical memory address range.

So in the preferred embodiment of my invention, the shared memory could be mapped to an I/O device such that DMA requests with addresses corresponding to the last sixteen Mbytes of a two hundred and fifty six Mbyte block of shared memory space would be forwarded directly to the memory controller and DMA requests with addresses corresponding to the balance of the two hundred fifty six Mbytes (0-239 Mbytes) would be forwarded directly to the CPU bus 22. In another embodiment, the memory could be mapped to an I/O device such that all DMA requests with addresses corresponding to any address in the entire two hundred and fifty six Mbyte block of shared memory space would be forwarded to the CPU bus.

The PCI target read buffer 322 is used by the computer system to support a type of pipelined read transaction. Under certain circumstances, the PCI target may have forwarded one or more read transactions to a computer system resource even though there is no active PCI bus read transaction in progress. Delayed reads and read prefetches are two such circumstances that would result in read transactions being buffered at the target read buffer. Read prefetches are typically used to speculatively bring data into the read buffer before the data is actually referenced. Read prefetches increase performance and decrease latency when large blocks of data are read and are recommended to be used with my invention.

The PCI target write buffer 323 is used to post write transactions. Specifically, the write address and data can be stored in the write buffer until the requested computer system resource is ready to perform the write. This allows the PCI target to terminate the bus cycle earlier, freeing the bus for other operations. Up to four write transactions can be posted by the write buffer.

The memory controller 330 accepts read and write transactions from the CPUs and from the I/O devices, manipulates the shared memory control, address, and data signals to perform reads and writes, and returns completion status and read data to the requesting computer system resource. The memory controller also generates coherency operations and forwards them to the CPU bus if these have been specified by the snoop address decoder 350. The snoop address decoder is used to decode ranges of addresses on each bus that are subject to one of several types of coherency management.

As previously mentioned, with the exception of the CPU arbitration unit 370, all of the system controller functional units are in communication with the system controller bus 340. The CPU arbitration unit operates to resolve multiple simultaneous requests for the CPU bus 22 by, for example, any one of the CPUs 11 or another device on the CPU bus, or by the CPU master 311.

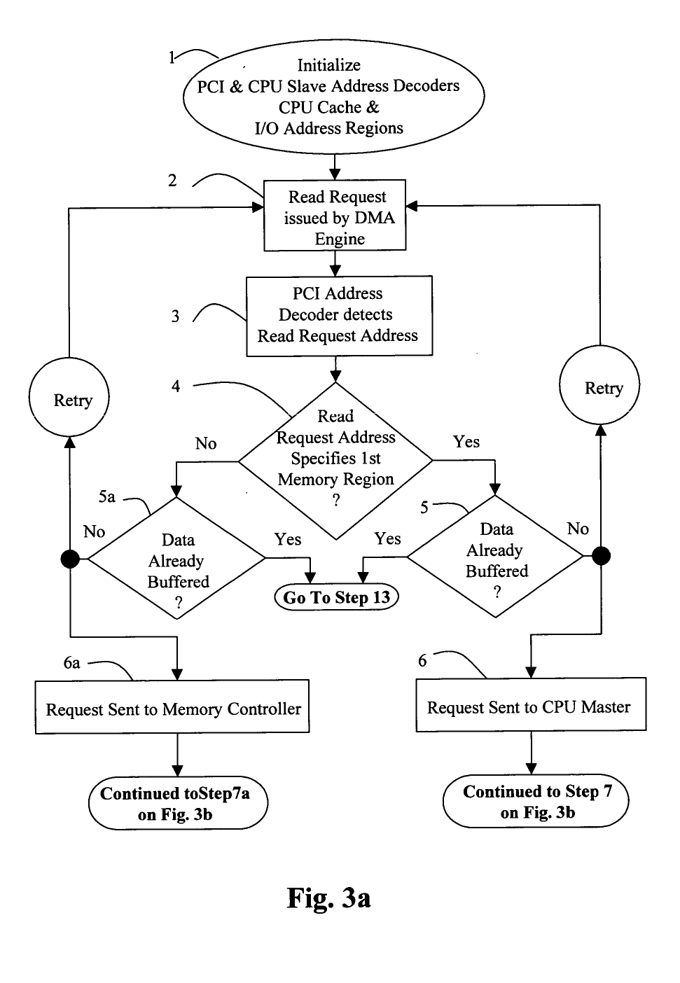

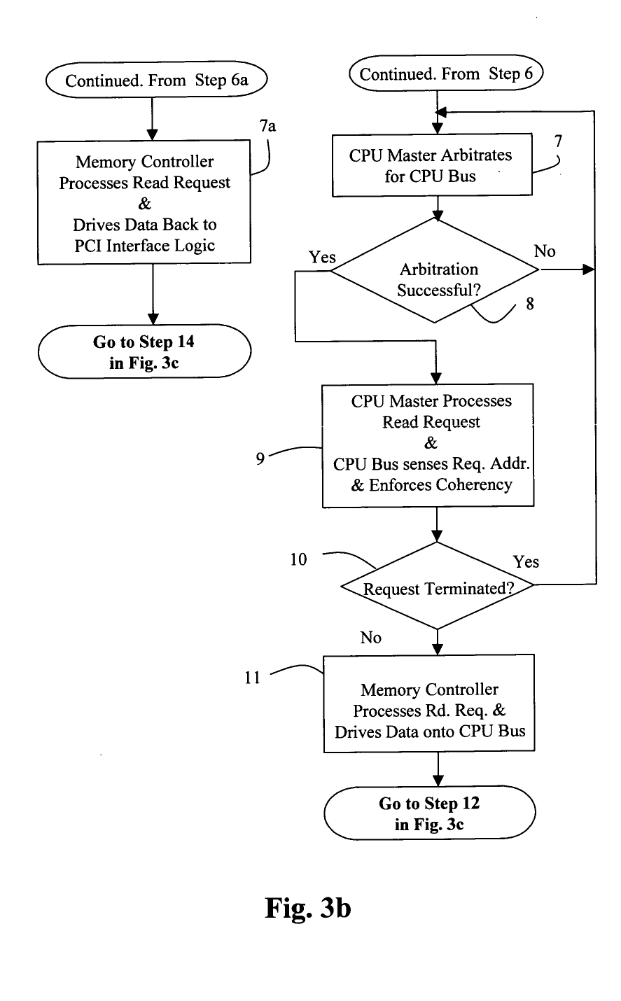

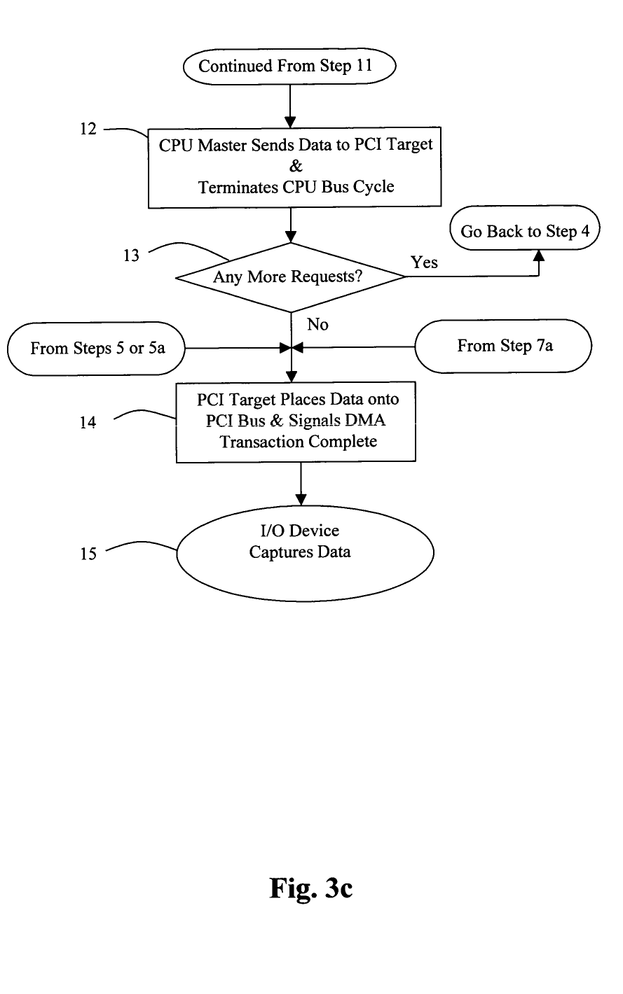

An example of a DMA transaction that uses the preferred embodiment of my invention will now be described with reference to the DMA read transaction logical flow diagram of FIG. 3a, b, and c. I have elected to describe a read transaction because my invention is particularly well suited to processing DMA read transactions in a very efficient manner. I will not describe a DMA write transaction in this application as I believe that it is obvious, to someone skilled in the art, how my invention would be utilized in this manner. The DMA transaction description that follows assumes that the PCI and CPU bus maps use the same base address for memory. Further, it should be understood that the steps and the sequence of the steps described with reference to FIGS. 3a, b, and c could be different depending upon the system controller used and the manner in which the computer system registers are initialized. The following description is not meant to limit the scope of my invention to this embodiment only.

At Step 1, the computer operating system programs the PCI address decoder 325 to discriminate between two memory address ranges and it programs the CPU slave decoder to respond to all shared memory addresses. The computer operating system also programs the CPU's cache to only cache data associated with the memory address range that corresponds to an I/O transaction processed in a coherent manner. The above two ranges are pre-selected by the user. Typically, the computer operating system would be able to run some routines in order to determine the address ranges used for certain types of DMA transactions, i.e., data or housekeeping transactions. These ranges may be identical on the CPU and 1,0 buses or the I/O bus addresses may be mapped to equivalent ranges of CPU addresses.

Step 2 starts when the DMA engine 520 associated with I/O device 50 on the I/O bus 52 generates a read request and drives it onto the I/O bus. Typically this would be a burst read. It should be understood that any device on either I/O bus 52 or 53 could generate a DMA read request and I only refer to a particular I/O device on a particular bus for the purpose of illustration. The process whereby a computer system operates to control DMA functionality by an I/O device will not be explained here as this is well know to those skilled in the art of computer software design. This read request could contain housekeeping information, it could contain data information, or it could contain both housekeeping and data information.

In Step 3, the PCI interface logic 320 detects the read request on the I/O bus 52 and passes the request to the PCI address decoder 325. As mentioned previously, the PCI address decoder operates to associate ranges of I/O addresses with computer system resources. In the preferred embodiment shown in FIG. 3, the address decoder is programmed to associate I/O addresses with either a first or a second memory address range but in another embodiment of the invention, there could be only a single memory address range.

In Step 4, the address decoder operates to associate the I/O address with the first memory address range or not. If the I/O address corresponds to the first memory address range, the process continues to Step 5, otherwise it proceeds to Step 5a.

At Step 5, the PCI interface logic 320 checks to see if the requested read data is already buffered in PCI read buffer 322, due to any prefetching operation conducted by the computer system. If so, then the transaction jumps to Step 13, if not, then the interface logic proceeds to terminate the bus transaction with retry. Retry makes the PCI bus available for other transactions until the read data is ready. The DMA engine will keep retrying the request until read data is available. At the same time that the interface logic generates a retry, the DMA request is sent directly to the CPU Master 311 in Step 6.

In Step 7, after receiving the DMA request, the CPU master 311 signals the arbitration unit 370 to arbitrate for the CPU bus 22. In Step 8, the arbitration unit generates control signals that make the CPU bus available to the CPU master unit or if not, keeps arbitrating for the CPU bus. Assuming that arbitration for the CPU bus is successful, then in Step 9 the CPU master unit performs a read transaction, typically a burst read, at the address specified by the request. Continuing to refer to Step 9, the CPU's coherency protocol observes the transaction request address and enforces coherency. It may be necessary at this point, depending upon the result of the coherency operation, to interrupt or terminate the bus cycle to write data cached at a CPU back to shared memory. The system controller I used requires that the CPU be run in a mode where the cycle is retried after cached data is written to memory. Other system controllers and/or CPU's may be able to perform the memory update simultaneously with the read cycle. If the cycle is terminated, as in Step 10, the process would go back to Step 7 and the CPU master would rerun the cycle. If the cycle was not terminated, the process would proceed to Step 11.

In Step 11, the memory controller 330 drives suitable signals to read the requested data from shared memory 40, drives the data onto the CPU bus 22, and signals that the data is ready. In Step 12, the CPU master 311 receives the data and sends it to the PCI interface logic 320 or the CPU master might temporarily store the data in the read buffer 312 until the PCI interface logic is ready to accept the data. Referring to Step 12, if the PCI interface logic 320 has buffered additional read requests, the process returns to Step 4 and the read request would be processed as before in parallel with Step 14. Regardless, the process proceeds to Step 14, and when the PCI interface logic has collected enough data to satisfy all or a programmatically-specified portion of the original read request, the PCI interface logic drives the data to the I/O bus 52 and signals that the read transaction is complete. At Step 15, the requesting I/O device captures the data driven by the PCI interface logic and issues a new read request if the original request has been only partially completed.

Now returning to Step 4, if the I/O address does not correspond to the first memory address range, the PCI address decoder 325 associates the I/O address with the second memory address range and then, in Step 5a checks to see if the requested data is already buffered in the PCI read buffer 322. If not, then the PCI interface logic 320 proceeds to terminate the read transaction on a retry and at the same time sends the read request directly to the memory controller 330. The memory controller processes the read request in a manner similar to that of Step 11 except that the CPU bus and the coherency protocol is not involved. After the requested data has been fetched, the memory controller drives the data back to the PCI interface logic and the process proceeds to Step 14.

The embodiments of my invention described in this application are not intended to be limited to single CPU or I/O bus implementations, nor is my invention limited to one or two memory address ranges. I can foresee that a system controller could operate in modes that would permit the definition of three or more memory address ranges that could be used to further improve computer system DMA processing performance.

1. In a general purpose computer system incorporating at least one CPU and associated cache in communication with a CPU bus, at least one I/O device in communication with at least one I/O bus, the at least one CPU and associated cache and the at least one I/O device are all in communication with a shared memory, the communication provided by a system controller having CPU interface logic and I/O interface logic and having a plurality of operational modes, a method for processing I/O transactions between the at least one 1,0 device and the shared memory comprising:
A) assigning first and second memory address ranges to the at least one I/O bus;
B) programming the CPU interface logic to respond to all addresses that correspond to shared memory;
C) programming the CPU cache to only store data corresponding to one of the memory address ranges;
D) programming the system controller to distinguish between the first and the second memory address ranges and to operate in a first mode if the system controller detects an I/O request address corresponding to the first memory address range and to operate in a second mode if the system controller detects an I/O request address corresponding to the second memory address range;
E) receiving at the system controller an I/O request from the at least one I/O device; and
F) forwarding the I/O request to the shared memory if the system controller is operating in the first mode and to the CPU bus if the system controller is operating in the second mode.

2. The method of claim 1, wherein the first memory address range corresponds to an I/O transaction processed in a non-coherent manner and the second memory address range corresponds to an I/O transaction processed in a coherent manner.

3. The method of claim 1, wherein the cache is programmed to store data corresponding to the second memory address range.

4. The method of claim 1, wherein the first and second memory address ranges are different sizes.

5. The method of claim 1, wherein the first and second memory address ranges are the same size.

6. The method of claim 1, wherein the first operation mode processes the I/O request non-coherently and the second operation mode processes the I/O request coherently.

7. The method of claim 1, wherein the step of programming the system controller includes setting an I/O address decoder on the system controller.

8. The method of claim 1, wherein the at least one I/O bus is a processor bus.

9. In a general purpose computer system incorporating at least one CPU and associated cache in communication with a CPU bus, at least one I/O device in communication with at least one I/O bus, the at least one CPU and associated cashe and the at least one I/O device are all in communication with a shared memory, the communication provided by a system controller having CPU interface logic and I/O interface logic, a method for processing I/O transactions between the at least one I/O device and the shared memory in a coherent manner comprising the steps of:
A) assigning a memory address range to the I/O bus;
B) programming the CPU interface logic to respond to all addresses that correspond to shared memory;
C) programming the CPU cache to store data corresponding to the assigned memory address range;
D) programming the system controller to detect I/O requests in the assigned memory address range and to operate in a coherent mode if the the system controller detects an I/O request in the assigned memory address range;
E) receiving at the system controller an I/O request from the I/O device; and
F) forwarding the I/O request to the CPU bus.

10. The method of processing I/O transactions in claim 9, wherein the I/O request corresponds to the assigned memory address range.

11. The method of processing I/O transactions in claim 9, wherein the step of setting the system controller includes programming the I/O address decoder so that the memory address range selects the CPU master unit.

12. In a general purpose computer system incorporating at least one CPU and associated cache in communication with a CPU bus, at least one I/O device and at least one CPU both in communication with a processor bus, the at least one CPU and associated cache and the at least one I/O device are all in communication with a shared memory, the communication provided by a system controller having CPU interface logic and processor bus interface logic and having a plurality of operational modes, a method for processing I/O transactions between the at least one I/O device and the shared memory comprising:
A) assigning first and second memory address ranges to the processor bus;
B) programming the CPU interface logic to respond to all addresses that correspond to shared memory;
C) programming the CPU cache to only store data corresponding to one of the memory address ranges;
D) programming the system controller to distinguish between the first and the second memory address ranges and to operate in a first mode if the system controller detects an I/O request address corresponding to the first memory address range and to operate in a second mode if the system controller detects an I/O request address corresponding to the second memory address range;
E) receiving at the system controller an i/O request from the at least one I/O device; and
F) forwarding the I/O request directly to the shared memory if the system controller is operating in the first mode and directly to the CPU bus if the system controller is operating in the second mode.

13. The method of claim 12, wherein the first memory address range corresponds to an I/O transaction processed in a non-coherent manner and the second memory address range corresponds to an I/O transaction processed in a coherent manner.

14. The method of claim 12, wherein the cache is programmed to store data corresponding to the second memory address range.

15. The method of claim 12, wherein the first and second memory address ranges are different sizes.

16. The method of claim 12, wherein the first and second memory address ranges are the same size.

17. The method of claim 12, wherein the first operation mode processes the I/O request non-coherently and the second operation mode processes the I/O request coherently.

18. The method of claim 12, wherein the step of programming the system controller includes setting a PCI target address decoder on the system controller.
